(19) United States
(12) Patent Application Publication
(10) Pub. No.: US 2003/0097319 A1
(43) Pub. Date: May 22, 2003

(54) Method for business solutions

(76) Inventors: Vlad Moldovan, Brookfield, WI (US); Mircea Moldovanu, Brookfield, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 09/992,749

(22) Filed: Nov. 16, 2001

(51) Int. Cl. G06F 17/60

(52) U.S. Cl. 705/35

(57) ABSTRACT

A method for providing business solutions for use by a company that improves the company's performance and profitability incorporates a number of interrelated ideas that can increase the productivity of the company and also lower the cost of products and services provided by that company or by its related companies. The method also provides the necessary capital to expand such a business by manufacturing products in other parts of the world, increases exports for that business and optimizes taxes and merger and acquisition costs.

### FIELD OF THE INVENTION

The present invention relates generally to methods for improving business performance and profitability. More particularly, it relates to a method that incorporates a number of interrelated ideas which, if implemented correctly, can increase the productivity of a business and also lower the cost of products and services provided by that business or by its related companies. It also relates to a method that provides the necessary capital to expand such a business by manufacturing products in other parts of the world, increases exports for that business optimizes taxes, merger(s) and acquisition costs. Such ideas are referred to generically throughout this application as “business solutions.”

### BACKGROUND OF THE INVENTION

In the experience of this inventor, there are methods that can be implemented to improve the performance and profitability of certain companies. The present invention describes and claims specific method(s) that incorporates a number of interrelated ideas which, if implemented correctly, can increase the productivity of a business and also lower the cost of products and services provided by that business or by its related companies. As mentioned above, such ideas are referred to generically throughout this application as “business solutions.” The business that implements these business solutions is referred to as “the company” (or “COMPANY”) and the person or individual doing most of the acquisitions work described in this application can be the chief executive officer (or CEO) of that company. A franchise shall carry the name of the office equipment manufacturer mentioned in this application as “ENTERPRISE 2” and it is called, generically, “Office Equipment Maker.” This company shall have exports in different parts of the world. In some cases, one enterprise (or “ENTERPRISE”) can provide the products and/or services produced by other ENTERPRISES, and vice versa. Additionally, the combination of an existing and new companies and/or services and operations that benefit by the financing methods described in this application will be known as the “PROJECT.” And the “CONTRACTOR” is a qualified existing or new overseas company interested in the manufacturing and/or assembling of the products contracted out by the “COMPANY.”

### SUMMARY OF THE INVENTION

Accordingly, it is an object of the present invention to provide a method for use by a company that wants to improve its performance and profitability. It is another object to provide such a method that increases its productivity while lowering the cost of products and services provided by that business or by its related companies. The method of the present invention obtains these objects by requiring the company to divest itself of certain businesses that it controls, to negotiate the trade with other businesses and to increase its business service operations by acquiring other companies that are specialists in their respective areas of products and/or services. It also provides an alternative to the company for its method of compensating company employees, consultants and franchises.

The ideas and the method of the present invention applies, but is not limited to, the following types of businesses:

1. Companies who have had or have consumer phone business and did and/or want to get out of that business by selling the business to small foreign telecom companies.

2. Companies who presently sell products and/or services to airlines and have very good, long term relationships with them.

3. Companies who presently sell products and/or services to local power or natural gas distribution companies and have very good, long-term business relationships with them.

4. All of those companies that must invest or have investments in media companies for the reason(s) which will be described in more detail later.

### BRIEF DESCRIPTION OF THE DRAWINGS

FIG. 1 is a schematic diagram illustrating the proper implementation of the method of the present invention.

FIGS. 2a, 2b and 2c are a schematic diagram illustrating a financing scheme for the method of the present invention and pertaining to manufacturing contracts where facilities are adequate and the party has no money to buy materials.

FIGS. 3a, 3b and 3c are a schematic diagram illustrating a financing scheme for the method of the present invention and pertaining to a business opportunity with existing facilities but which needs modernization and operation capital.

FIGS. 4a, 4b, 4c and 4d are a schematic diagram illustrating a financing scheme for the method of the present invention pertaining to a new business opportunity that requires a new facility and operation capital.

FIG. 5 is a schematic diagram illustrating an optimization package for import/export business.

FIG. 6 is a schematic diagram illustrating an optimization method for mergers and acquisitions.

FIGS. 7a and 7b are a table of terms and abbreviations used throughout the detailed description and in the foregoing diagrams.

### DETAILED DESCRIPTION

The method of the present invention requires the following steps to be followed:

1. Increase the “COMPANY's” Business-Services Operation by Providing the Following Business Solutions Services.

Through “business solutions” this inventor means a wide range of recommendations that, if implemented correctly, can save money to the owner(s) of that business. That business shall hire/buy (with cash and stock) the following personnel or companies. Also, the business solution shall be a franchise. (See description below)

People and/or companies who developed specialized hardware and software, who know and are able to select the above and provide customers with business solutions and maintain them and the system(s) offered, all at low cost.

The “business solutions” specialist(s) shall recommend methods and ways to improve and reduce the cost(s) associated with: purchasing raw materials, components, energy, production equipment and services, employees hiring and/or benefits, labor, organization's marketing, engineering, taxes, finance/financing arrangements, accounting, communications, travel, transportation, shipping, legal services, insurance, management, compensation levels, paper work and union(s) relations, domestic and international. All savings shall be quantified in US dollars through a feasibility study. All business saving measures (or BSM) recommended to clients, must be described, without details of any kind, except the cost in the feasibility study. The business owner/manager shall have the opportunity to evaluate the benefit(s) vs. cost(s) in US dollars. All results of the study shall be discussed with the client's designated management representative; which shall be the decision maker. He/she shall make the selection and decision to go ahead. The customers will be small and medium size companies from a wide spectrum of businesses. They do not have this kind of expertise, resources to hire and retain, specialized consultant(s), or employees, but need the services to survive and/or to become more competitive and grow domestic and international. The “COMPANY” should hire/contract these experts, which will form the “Management Advisory Team,” as “COMPANY” employees or consultants and they shall be paid a small retainer, to be sure that they are available to work on short notice. This way, the “COMPANY” can count on their availability and they can retain their existing clients who count on their reliability. The “COMPANY” shall strategically locate a team in a number of cities, located across the United States, each of which has at least one major league sports team, regardless of the type. All consultants and/or employees can be found locally. In some instances, there could be exceptions to this.

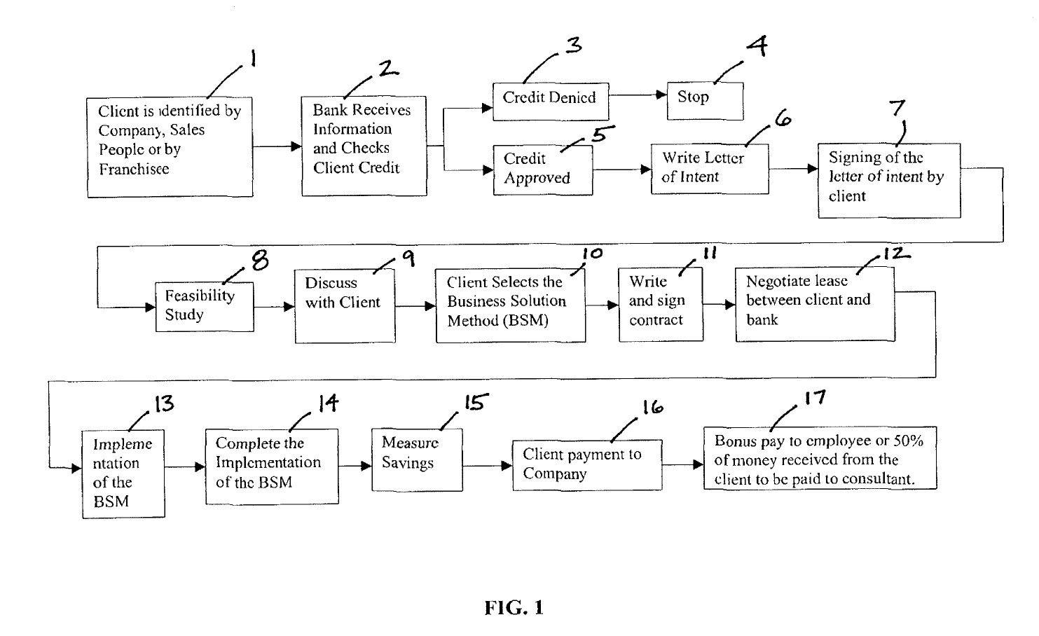

Referring now to FIG. 1, when “COMPANY” sales people or franchise identify 1a prospective client, interested in some or all of the above, they shall pass the information 2 on to the financial institution, or “bank” (the BANK) which can evaluate the prospective client's credit 3, 4, 5. Once the BANK approves it 5 they can proceed further. The next step is to draw up a letter of intent 6 to be signed by the customer 7. The branch sales people shall call on the company's owners and/or boards chairmen. The letter of intent shall be written by/on “COMPANY” branch business manager/stationeries that carry more weight than franchisees. This letter of intent shall specify that, if the study 8 is done and some or all of the BSM are bought and/or implemented 13, 14, 15 the customer shall compensate 16 the “COMPANY” for its work, with a substantial, negotiated percentage (60-90%) of the savings 15, for a period of three (3) years, starting from the day when the implementation was complete and/or warranty did start. The liabilities, percentages, verification and time of payment shall be well defined in the above-mentioned letter. Only after the letter is signed, the “COMPANY” shall send a management advisory team (the “MAT”) to work on the study. After the study is completed, it will be discussed with and reviewed by the client 9 and the BSM selected 10. The contract will be signed 11. The company people shall negotiate the lease with the financial institution 12. The “MAT” and customer shall have a very good idea about the situation(s) before and after. The client, together with the “COMPANY” MAT that implemented and/or supervised implementation shall be aware of the results. This inventor suggests that evaluation(s) and payment(s) to the “COMPANY” be made quarterly. Each payment received from a customer shall specify the field of BSM that generated the savings (accounting, travel, employee benefits, marketing, etc).

The members of the MAT shall be compensated 17 in the following manner:

a) The “COMPANY” employees shall receive a small but decent salary, full benefits for them and their families and a large, one time bonus proportional with the revenues generated by them for the “COMPANY,” from each customer. The recommended bonus would be 5%.

b) Consultants shall receive a small but decent monthly retainer, no benefits and 50% of each payment received by the “COMPANY,” for each of their successfully implemented BSM.

c) The franchisee shall receive a 10% discount on all “Office Equipment Maker” brand equipment and software purchased through the “COMPANY” and required on their jobs. For the first customer found by them in that year who needed assistance from the “COMPANY's” business solutions group, the discount shall be an additional 5%. For the next 3 customers, in the same year, identified by them and needing the “COMPANY” help, the discount shall be an additional 5% of the precedent discount which is 0.25%.

2. Increase the “COMPANY's” Business-Services Operation by Acquiring the Following Companies which are Necessary to Implement “Business Solutions.”

2.1 Acquire, through a negotiated share exchange, ENTERPRISE 1, an assembler/manufacturer/trader/up-grader of desktops, portable and other computers and computer services needed by a wide range of markets.

2.2 Acquire, through a negotiated share exchange, ENTERPRISE 2, a manufacturer of office equipment and services.

2.3 Acquire, through a negotiated share exchange, ENTERPRISE 3, a provider of software and services designed to greatly increase the productivity, reliability and recoverability of its client's core informational technology (or IT) operation.

2.4 Acquire, through a negotiated share exchange, ENTERPRISE 4, a supplier of application server software and services that enable the effective and efficient enterprise-wide deployment and management of applications, including those designed for Microsoft.

2.5 Acquire, through a negotiated shares exchange, ENTERPRISE 5, a designer, developer, manufacturer and marketer of digital imaging products and services.

2.6 Acquire, through a negotiated shares exchange, ENTERPRISE 6, a developer, marketer and supporter of systems software products that are designed to improve productivity in application development, implementation and maintenance and also offers system analysis, design, programming, system planning and/or consulting.

2.7 Acquire, through a negotiated shares exchange, ENTERPRISE 7, a designer, manufacturer and marketer of computer-based information systems and related products and services.

2.8 Acquire, through a negotiated shares exchange, ENTERPRISE 8, a provider of information technology services through: outsourcing (operating customer's technology infrastructure), system integration (designing, developing and implementing information systems), IT and management consulting services.

2.9 Acquire through a negotiated shares exchange, ENTERPRISE 9, a telecom company involved in networking, enterprise/consumer and telecom components. It also designs, develops, manufactures and/or services systems and software which enable network operators and other service providers to provide wire line/wireless access. The networking solutions and services support voice, data and video transmissions. In addition to the above, it manufactures products and/or systems for mobile communications. ENTERPRISE 9 will provide low cost communications for all markets described.

2.10 Acquire through a negotiated shares exchange, ENTERPRISE 10, a machine tool and factory automation company that is engaged in research, development, manufacture and service of machine tools, electronic controls and communication products including control logic, sensors, human-machine interface devices and/or software products.

2.11 Acquire through a negotiated shares exchange, ENTERPRISE 11, an energy savings company (ESCO), that will advise the customer how to save energy, reduce the purchasing cost(s) and identify the low cost supplier(s) in that area.

2.12 Acquire through a negotiated shares exchange a software company, ENTERPRISE 12, whose main products are helping clients with their income taxes and project/investment financial analysis, decisions and/or software.

Where franchised, the business and all products and services sold shall be under the “Office Equipment Maker” brand name. Otherwise, the products and services must be under the “COMPANY” name brand, sold by “COMPANY” employees. No exclusivity will be provided to any franchise for any designated area. Business will be conducted everywhere and with everyone. In effect, more that one company operating in the same area could implement the business solutions.

The “COMPANY” will have major advantages for a while due to the following reasons:

1) The “COMPANY” has a larger past or present business, an extensive customer base, and has a good and well-recognized name in its operating area.

2) Good relations with the phone, power and airline companies to whom the “COMPANY” sold the phone business or sells equipment and/or services to power companies and can and shall introduce the “COMPANY” to their past and/or present customers, for a finder's fee. The franchises, under the “Office Equipment Maker” name, shall be introduced, to their prospective clients by, the natural gas distribution companies operating in that area and/or, other phone companies also operating in the same territory, for a similar fee.

3) Passive investments in media organizations, which could broadcast commercials for “Business Solutions,” at reduced rate(s). It will require a massive, local advertising campaign with appeal to a wide range of parties: future customers, existing specialized companies interested in selling or franchising and prospective qualified employees.

4) Larger product line: computers, office equipment, software, networking products and/or services, consulting services, and relatively easy access to targeted market(s).

5) More distribution channels and two brands: The “COMPANY” and the “Office Equipment Maker.”

6) Good business relations with foreign phone companies to whom the “COMPANY” would sell, through negotiations, the consumer phone business. As an alternative for phone business, the “COMPANY” presently can sell, power or other utility equipment, to power companies and aviation equipment and services to airlines. To stimulate the “COMPANY”, prospective customers the power, natural gas, telephone and airlines companies can provide incentives to their customers who buy “Business Solutions” services, in the form of rebates or free tickets.

3. International Marketing and Business Opportunities

A) To successfully expand the “COMPANY” new “Business Solutions” business, the “COMPANY” should: develop new programs, software applications to accommodate the wide range of US customers, by contracting to foreign qualified companies.

B) Assemble computers, office equipment and other equipment overseas, through technology transfers, via joint ventures, with qualified partners.

C) Eastern Europe can provide many good workers, engineers and programmers, many of who are currently unemployed

D) The manufacturing managers must be provided by the “COMPANY.” It shall set up the quality control systems and use their experience gained at their past employer to assemble world class products at a very low cost.

E) If the products will be manufactured and/or assembled by the “COMPANY” joint ventures (or “JV's”) via a technology transfer or not, and/or when the final/partial product it is the “COMPANY” intellectual property or not, there are several different alternatives available: 1) existing facilities are adequate; 2) existing facilities need modernization; 3) new facilities are needed; and 4) any combination of these.

E1) Existing facilities are adequate and there is no need for expansion and/or modernization but needs operation captial. This is basically the case of the manufacturing contract and license where the contractor “C” does not have money to buy materials. The “COMPANY” must supply all necessary components to assemble the products through a technology transfer or not. A third party, with no other interest except well being of the new business, should identify overseas local, qualified parties and recommend them to the “COMPANY.” The third party compensation, the finder's fee, for finding a good business opportunity for the “COMPANY” and making all necessary arrangements shall be a share in that business provided by the “COMPANY.” The third party finder's fee for bringing business to financial institutions mentioned above shall be a share in that business, taken from their shares if they provide the equity, or cash if they provide the lease, or a combination. The contractor shall pay a finder's fee in shares of the business where F(s) provides equity. Also, some financial/technical feasibility study must be completed and presented to the “COMPANY” and to the financial institutions. Workers and management salaries and profits shall be in kind and the finished product belonging to them shall be sold on local/international markets through designated organizations. In this way, these two parties will be interested in quality, to increase the business and the bad habit of stealing will be prevented. Any missing finished product and/or parts shall be deducted from their shares of the finished product. All capital required to buy materials/components per “COMPANY” specifications to assemble and/or manufacture the finished product shall be provided as equity in a specific joint venture by one of the financial institutions described above. Also some financial/technical feasibility study must be completed and presented to the “COMPANY.” If the “COMPANY” is interested in principle, more studies must be done including a business plan based on a long-term contract given by “COMPANY” or his business associates to the business overseas.

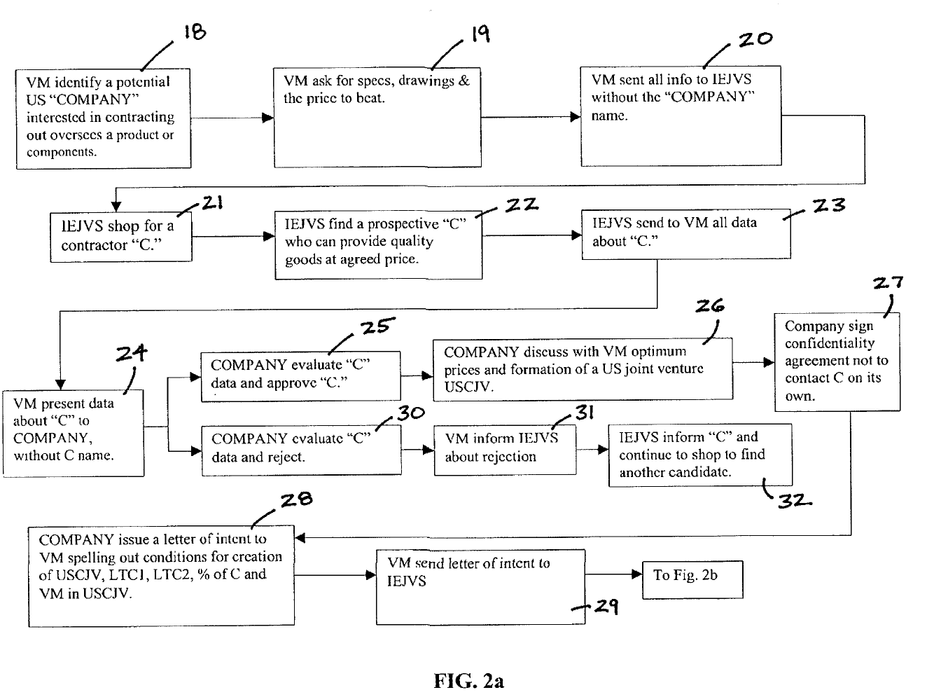

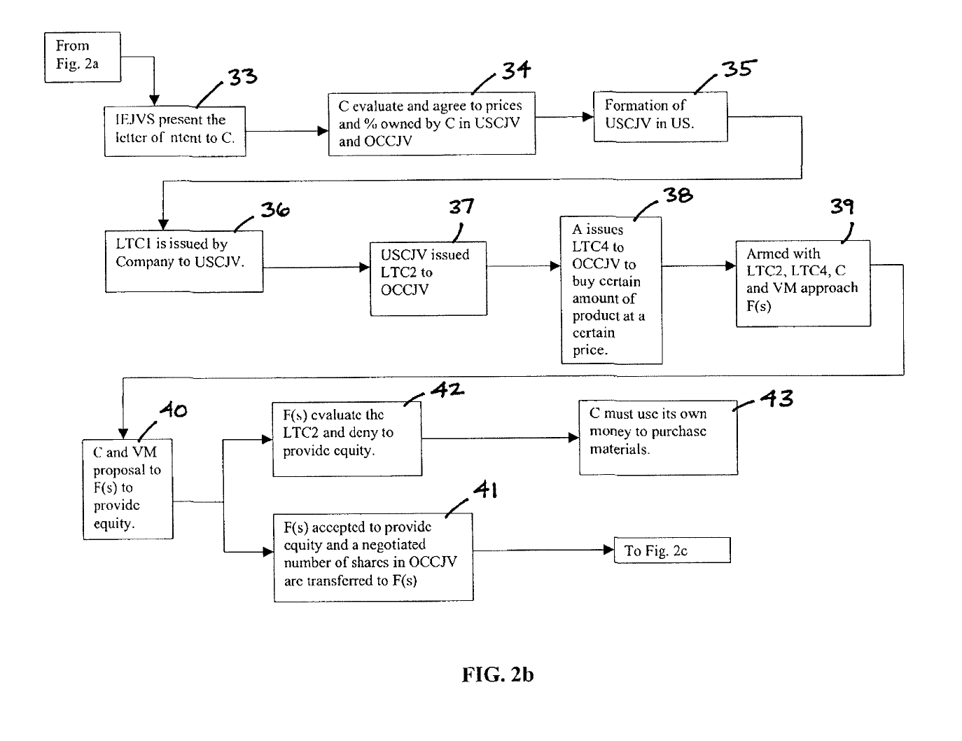

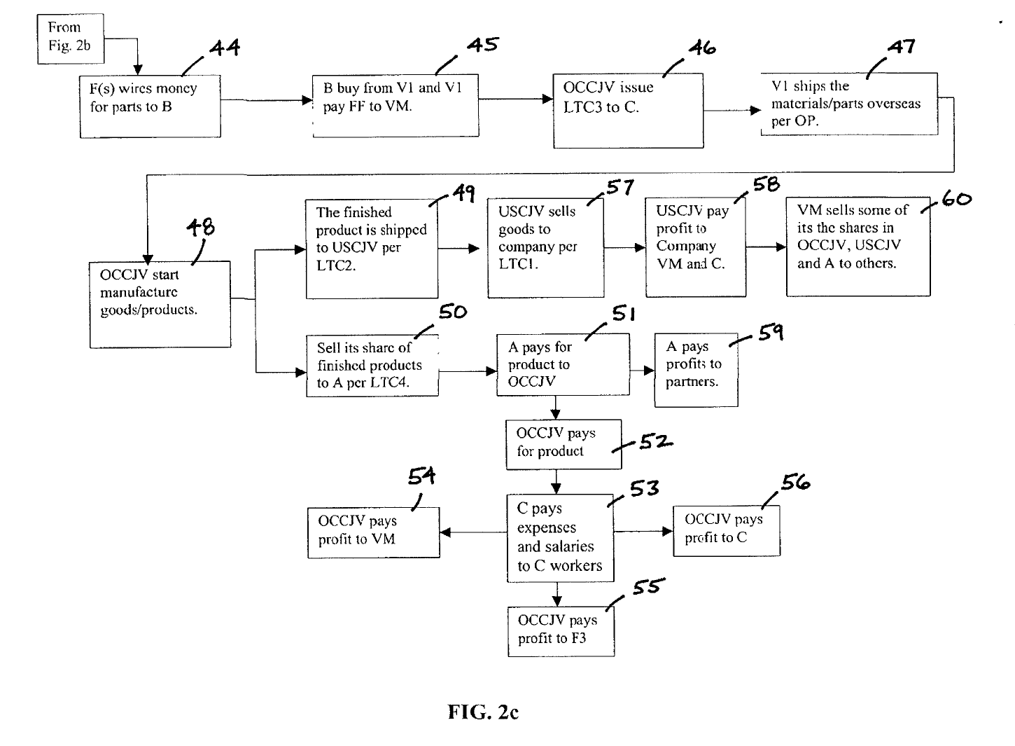

In this sequence of operation, this is basically the case of the manufacturing contract. See FIGS. 2a, 2b and 2c. VM shall identify 18 a potential US business, the “COMPANY,” interested in contracting out overseas a product and/or components. VM shall ask 19 the “COMPANY” for specs, drawings and the price to beat. After receiving all of that information, VM shall send it to IEJVS without the “COMPANY” name 20. IEJVS, armed with all information, shall start shopping 21 for a contractor “C.” After IEJVS finds a qualified “C” able to provide quality goods at the price to beat 22, it shall send 23 all data about “C” to VM. VM shall present 24 data about “C” to the “COMPANY.” If data is acceptable 25 to the “COMPANY,” VM shall propose to them 26 the formation of USCJV and OCCJV (the Project) and discuss the optimum prices for transferred goods between companies, LTC1 and LTC2. USCJV is a joint venture between “COMPANY,” VM and C and shall be located in the US in a low tax area and shall make most of the profits. OCCJV shall be a joint venture between C and VM in the country where C is located. If negotiations are successful, “COMPANY” shall sign a confidentiality agreement 27 and a letter of intent 28 spelling out all conditions for creation of ownership percentages in OCCJV, USCJV, LTC1, LTC2 and transfer the goods. C shall be paid in components/materials for his labor and usage of his facilities. The amount of finished products shipped to USCJV shall be spelled out clearly and so too the amount finished products belonging to C. The letter of intent shall be sent to IEJVS 29. If the “COMPANY” will reject 30 C, then other steps will follow 31,32. IEJVS shall present the letter of intent to C 33 and, if accepted by C 34, the USCJV and OCCJV shall be formed 35 and the “COMPANY” issues 36 the LTC1 to USCJV. USCJV shall issue 37 the LTC2 to OCCJV. A shall issue LTC4 to OCCJV for a specified amount of finished product at a certain price 38. Armed 39 with the LTC2 and LTC4, and other information, VM and C shall approach F(s) and propose to them being partners in a OCCJV 40. F's equity in the OCCJV shall be the capital required to purchase all materials as specified by the “COMPANY.” VM shall receive a percentage in OCCJV. If F(s) evaluates and accepts the OCCJV proposal, a negotiated number of shares in OCCJV shall become the property of F(s) 41: C provides facilities and labor, VM brought the contract and F(s) will provide the materials. If F(s) rejects 42, then another step 43 is followed. F(s) shall wire money, their equity, to B to buy materials from V1 44. B purchases materials from V1 45 and V1 pays a finder's fee to VM. OCCJV shall write LTC3 46 to C. V1 shall ship the materials/parts to OCCJV per OP 47. After the goods are produced 48, some are shipped to USCJV 49 and others are shipped to A 50 per LTC4. A pays for product received 51 per LTC4 to OCCJV. OCCJV pays C 52 per LTC3. C pays other expenses and salaries to C workers 53. OCCJVP pays profits to VM 54, F3 55 and C 56. A shall be a joint venture between VM and OTHERS. Upon arrival to the US, the transaction between UCCJV and COMPANY shall take place in accordance with LTC1 57. The goods shall be shipped directly to C facilities to “COMPANY” warehouses. The profits from UCCJV shall be passed on to partners 58. A shall pay the profits to partners 59. The cycle shall repeat. If the entire operation works as designed, VM can sell some of its own shares in USCJV, OCCJV and A to OTHERS and/or IEJVS 60.

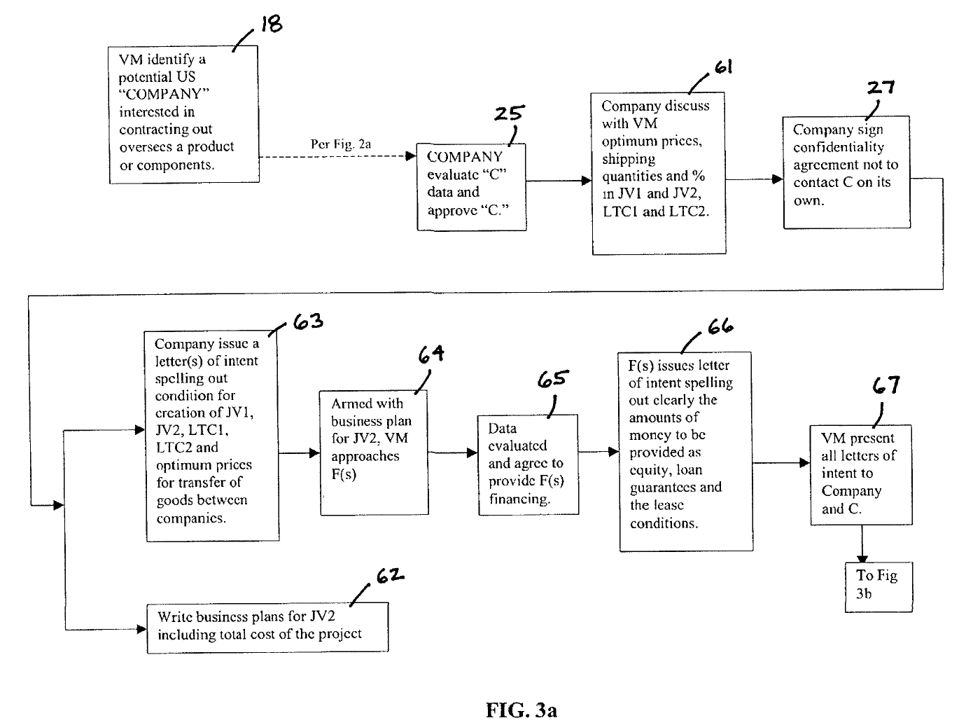

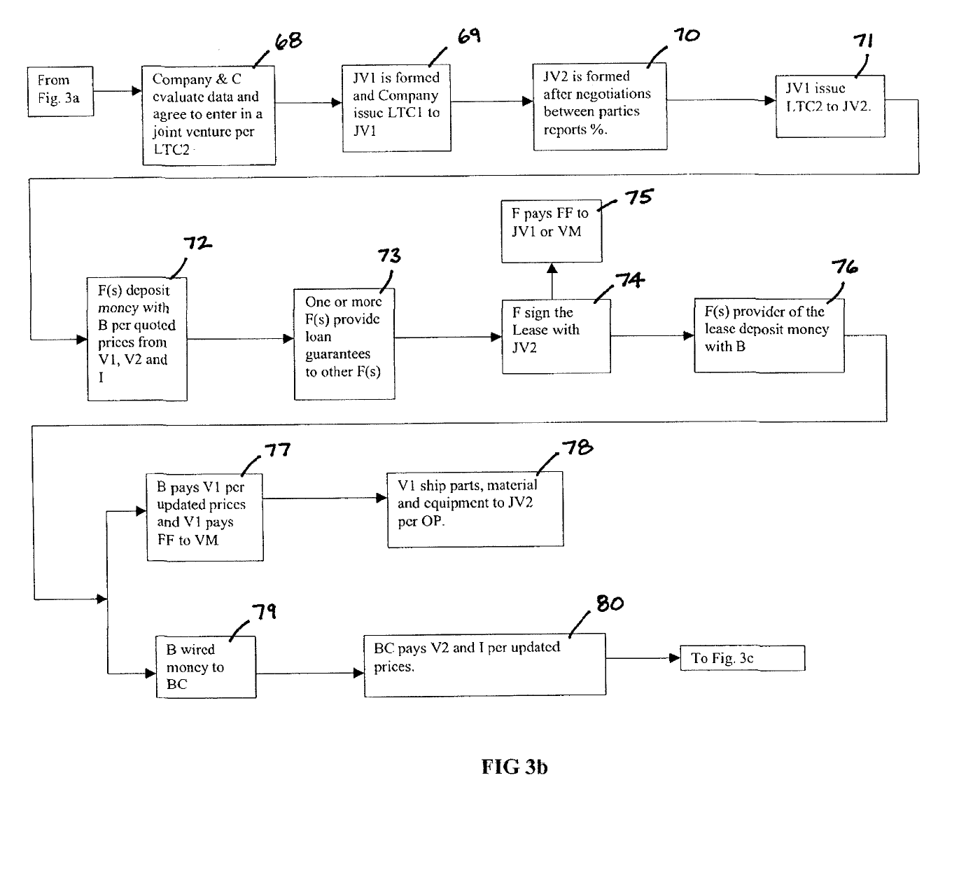

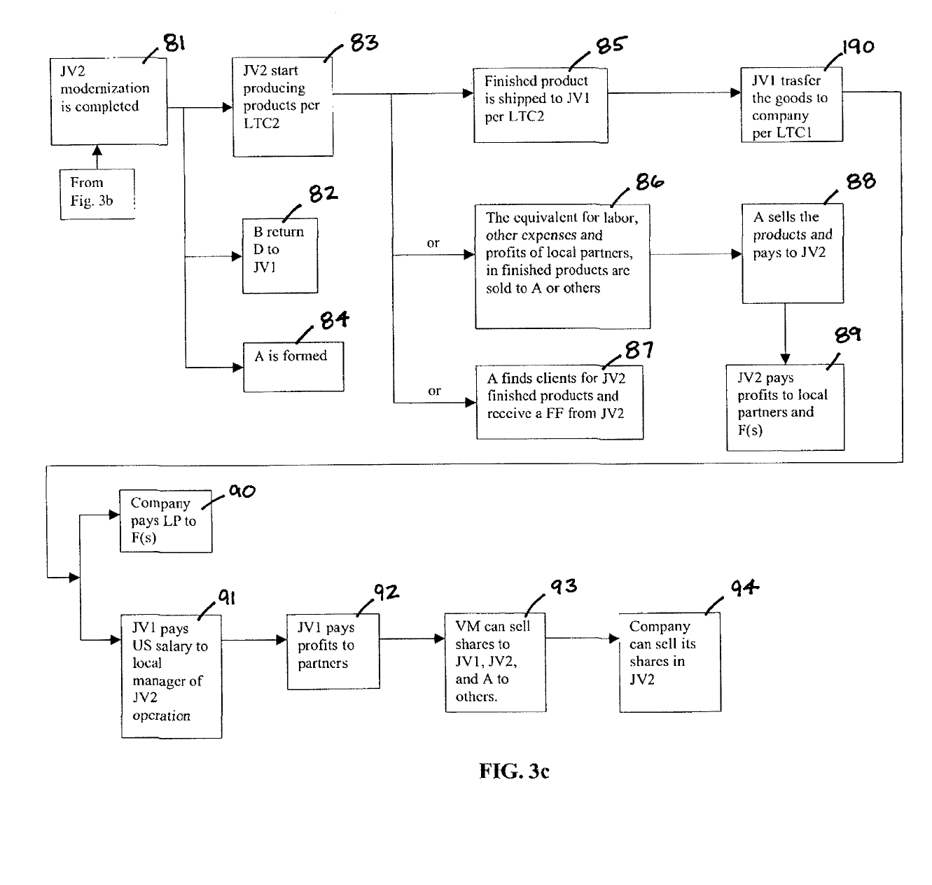

E2) Business has existing facilities that need some modernization and operation capital. In these JV's, the local partners shall be responsible for supplying and paying for all required labor, facilities expenses and utilities. See FIGS. 3a, 3b and 3c. The “COMPANY” must supply all necessary components to assemble the products through a technology transfer or not. In exchange for components/parts, know how and/or a long-term contract provided by the “COMPANY” or one of its subsidiaries and/or acquired with the “COMPANY” assistance, the “COMPANY” or its subsidiary shall receive a negotiated share in that joint venture. A third party with no other interest except the well being of the new business, should identify all local, qualified parties and recommend them to the “COMPANY.” The qualified partners can be any combination between the workers, owners and management of that plant and utilities operating in that area. The third party compensation, the finder's fee, for finding a good business opportunity for the “COMPANY” and making all necessary arrangements shall be a share in that business provided by the “COMPANY.” The third party finder's fee for bringing business to the financial institutions mentioned above shall be a share in that business taken from their shares if they provide the equity, cash if they provide the lease, or a combination. The third party finder's fee for bringing business to that operation shall be a share in that business taken out from the remaining shares of the owners of that business. The third party finder's fee for bringing business to qualified vendors through bidding or negotiated process shall be a percentage of that order.

If the project/plant will be built in certain locations overseas, all of the necessary capital for purchasing the raw materials, components, equipment and money for modernization/expansion can and shall be supplied as equity in a specific joint venture or as a lease by the financial institutions mentioned above. Workers and management salaries and profits shall be in kind and the finished product belonging to them shall be sold on local/international markets through designated organizations. In this way, these two parties will be interested in quality, to increase the business and the bad habit of stealing will be prevented. Any missing finished product and/or parts shall be deducted from their shares of the finished product. The utilities can introduce the JV2's local sales people to local, qualified, customers. The workers, management, owners and the “COMPANY” shall take the profits as agreed, in kind and in accordance to their share of the business.

Part or all of the capital required for construction and/or equipment-purchasing/installation can and shall be provided by one or more of the financial institutions mentioned above under a lease form. The building and/or equipment shall be leased to JV2. The “lease” shall be for a previously agreed upon period of time. The regular lease payments (LP), paid by lessee shall be equal or less than the profits generated in the same period of time by the percentage of the business assigned to the lessee. At the end of the lease, the property shall be transferred to the lessee at no cost. By doing this, all of the capital required to start and operate the business will be supplied by the financial institutions with no risk for other partners. This is “FREE INVESTMENT.” To ensure the optimum operation of the JV and to avoid problems of any kind with the products manufactured and/or assembled overseas, the responsible people employed by that overseas supplier shall receive a salary paid in US dollars in the United States. If there are problems, the salary shall not be paid and all or part of the damages must be deducted from their pay. After the lease is paid, “COMPANY” shall divest in time all of the holdings in the international joint ventures, via IPO's through overseas country stock markets and at a profit. All resulting cash will be transferred to the United States through the regular channels. The “COMPANY” shall continue to do business with its partners. The form of business should be a “License” and/or “Manufacturing Contract” which can also be a technology transfer or not.

The sequence of operation for a manufacturing contract/license that requires facilities modernization and capital for operation and/or to buy materials is shown in FIGS. 3a, 3b and 3c. VM shall identify 18 a potential US business that the “COMPANY” is interested in contracting out overseas a product and/or components to. VM shall ask 19 the “COMPANY” for specifications, drawings and the price to beat. After receiving all of the above information, VM shall send them to IEJVS 20 without the “COMPANY” name. IEJVS, armed with all information, shall start shopping 21 for a contractor “C.” IEJVS finds a qualified “C” able to provide quality goods at the price to beat 22 and shall sent 23 all data about “C” to VM. VM shall present 24 data about “C” to the “COMPANY.” If data is acceptable 25 to the “COMPANY,” VM will discuss/negotiate 26 with “COMPANY”: optimum prices, shipping quantities, percentages in JV1, JV2, LTC1, LTC2 and other important data. If negotiations are successful, “COMPANY” shall sign a confidentiality agreement 27. The JV2 business plan, feasibility study and/or the total cost of the project shall be written or determined 62 with the assistance of all parties. If the COMPANY rejects 30 C, then other steps are taken 31, 32.

COMPANY shall issue letter(s) of intent 63 spelling out clearly all conditions for creation of the JV1, JV2, OP's for transferring the goods between companies, LTC1, LTC2 and all other necessary data. Armed with a business plan 62 VM shall approach the F(s) 64. If the F(s) evaluate the data and agree 65 to provide financing, the F(s) shall issue letters of intent 66 spelling out clearly the amounts of money to be provided as equity, lease conditions and all other requirements. VM shall present 67 all letters of intent to COMPANY and to C. COMPANY and C shall evaluate 68 the F(s)'s letters and if they agree shall enter in a joint venture per LTC2. JV1 is formed 69 and COMPANY issues the LTC1 to JV1. C shall become JV2 after negotiations 70 between all parties: W, M, VM, COMPANY, F(s) and C owners, if they exist. JV1 shall issue 71 the LTC2.

Some of the F(s) providing the equity capital shall deposit the money 72 needed for the “PROJECT” in accordance with the feasibility study, to B. One or more F(s) shall issue the loan guarantees 73 to other F(s). One or more F(s) shall sign 74 the lease agreement with JV2. The F(s) who obtained the lease business shall pay 75 the finder's fee(s) to JV1 or VM. The F(s) providing the lease shall deposit money 76 in accordance with the feasibility study and their letter of intent to B. B pays 77 V1 per updated prices and V1 pays the finder fee to VM. V1 shall ship the purchased materials/equipment to JV2 with the shipping documents 78 stating the OP(s) as decided by the buyers and/or sellers. B shall wire 79 money to BC. BC pays V2 and I per updated prices 80 and V2 and I pays a finder's fee to VM as agreed. The final payment to I shall be one year after JV2 modernization 81 is completed. V1 shall start shipping components and JV2 shall assemble/manufacture 83 per LTC2. B shall return D, which is the profit 82 from the project and/or project management fee to JV1 or VM. A shall be identified or formed 84.

The finished products are shipped 85 to JV1 per LTC2 but at the location or warehouse decided by “COMPANY.” The equivalent for labor, other expenses and profits, in finished products per LTC2 who belongs to the local partners/employees are sold to A and/or others 86 or if A finds clients 87 for the finished products shall be paid a FF by JV2. A pays 88 to JV2 for products before and/or after it sells them to others. JV2 pays 89 the profits to local partners and the F(s) who provided the equity capital. “COMPANY” pays LP 90 to the F(s) who are the lessors. JV1 pays 91 US salary in US dollars to a local manager/person responsible for JV2 operation. JV1 shall pay 92 the profits to the partners in the United States. VM can sell 93 some shares in JV1, JV2 and A to others. After the lease is paid, the “COMPANY” can sell its share in JV2 94 to local buyers. Profits shall be paid after each shipment or as agreed by all parties.

E3) Business Needs New Plant and Operation Capital. A third party with no other interest except for the well being of the new business, should identify overseas local, qualified parties and recommend them to the “COMPANY.” The qualified partners can be any combination between the workers and management of that plant and utilities operating in that area. In these JV's, the local partners shall be responsible for supplying and paying for all required labor, facilities expenses and utilities. The “COMPANY” must supply all necessary components to assemble the products through a technology transfer or not. In addition to that, “COMPANY” shall be responsible for providing funds and the specifications to built the new plant. The qualified partners can be any combination between the workers and management of that plant and utilities operating in that area.

The third party finder's fee, for bringing business to financial institutions mentioned above, shall be a share in that business, taken from their shares if they provide the equity, cash if they provide the lease, or a combination. The third party finder's fee for bringing business to that specific area shall be a share in that business in that area. The third party finder's fee for bringing business to “COMPANY” shall be a share in that business taken from the “COMPANY” shares. The third party finder's fee for bringing business to qualified vendors through bidding or negotiated process shall be a percentage of that order.

If the “Project”/plant will be built overseas, all of the necessary capital for purchasing the raw materials, components, equipment and money for new plant construction can and shall be supplied, under the form of equity in a specific joint venture or as lease, by the financial institutions mentioned above. Workers and management salaries and profits shall be in kind and the finished product belonging to them shall be sold on local/international markets through designated organizations. In this way, these two parties will be interested in quality, to increase the business and the bad habit of stealing will be prevented. Any missing finished product and/or parts shall be deducted from their shares of the finished product. The utilities can introduce the JV2's local sales people to local qualified customers. The workers, management, other owners and the “COMPANY” shall take the profits as agreed, in kind and in accordance to their share of the business and when agreed.

Part or all of the capital required for construction and/or equipment-purchasing/installation can and shall be provided by one or more of the financial institutions mentioned above under a lease form. The building and/or equipment shall be leased to JV2. The “LEASE” shall be for a previously agreed upon period of time. The regular lease payments (LP), paid by lessee shall be equal or less than the profits generated in the same period of time by the percentage of the business assigned to the lessee. At the end of the lease, the property shall be transferred to the lessee at no cost. In this way, all capital required to start and operate the business will be supplied by the financial institutions with no risk for other partners. As before, this is “FREE INVESTMENT.”

To ensure the optimum operation of the JV and to avoid problems of any kind with the products manufactured and/or assembled overseas, the responsible people employed by that overseas supplier shall receive a salary paid in US dollars in the United States. If there are problems, the salary shall not be paid and all or part the damages must be deducted from their pay.

After the lease is paid, “COMPANY” shall divest in time of all holdings in the international joint ventures, via IPO's through overseas country stock markets, and at a profit. Transfer of all resulting cash to the US shall be made through the regular channels. The “COMPANY” shall continue to do business with its partners. The form of business should be a “License” and/or “Manufacturing Contract” which can be also a technology transfer or not.

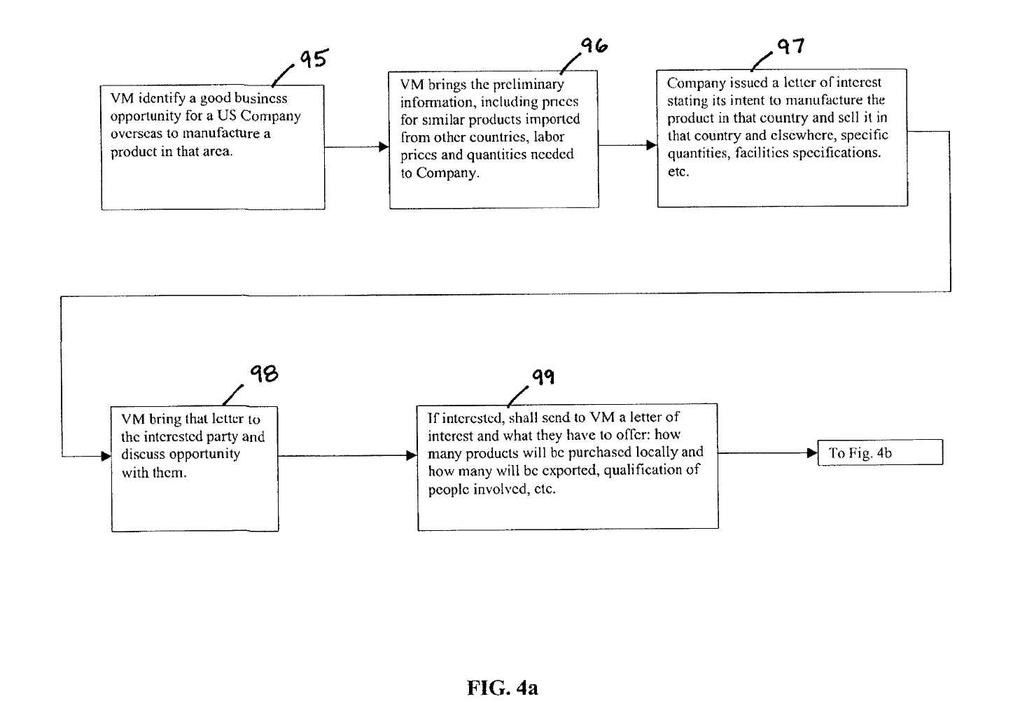

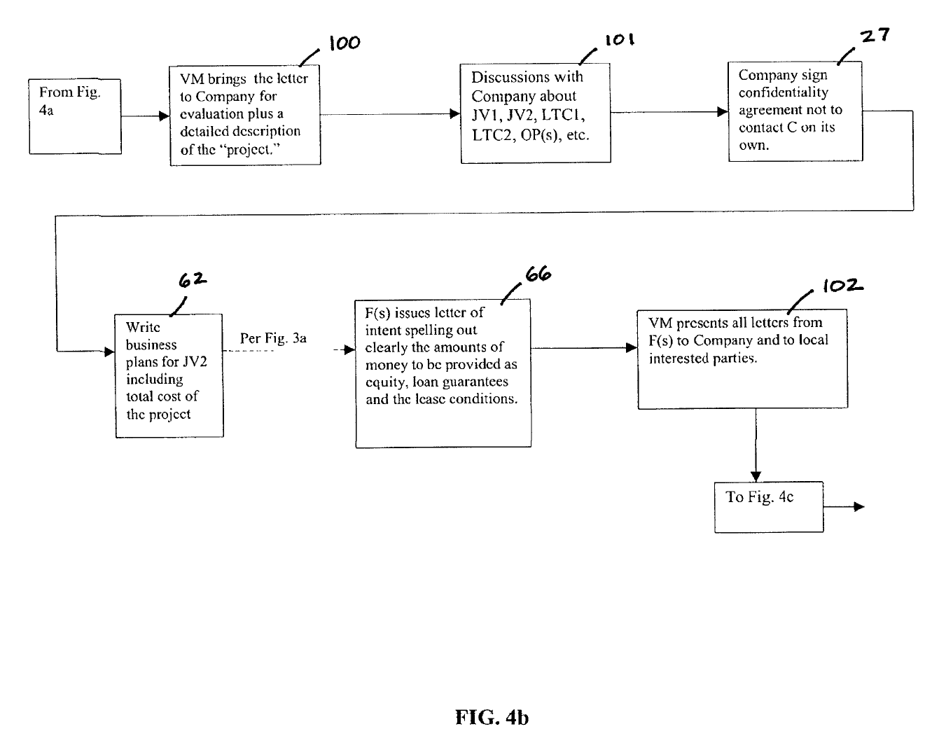

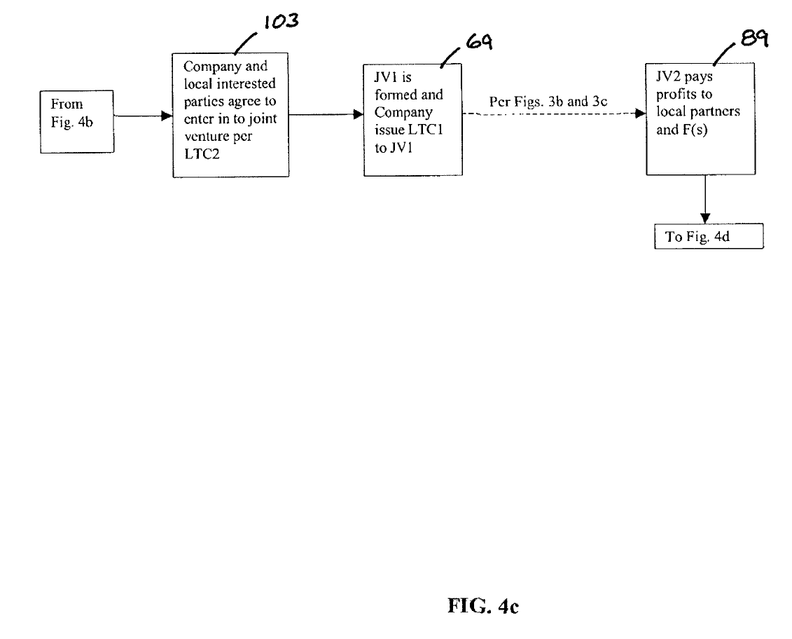

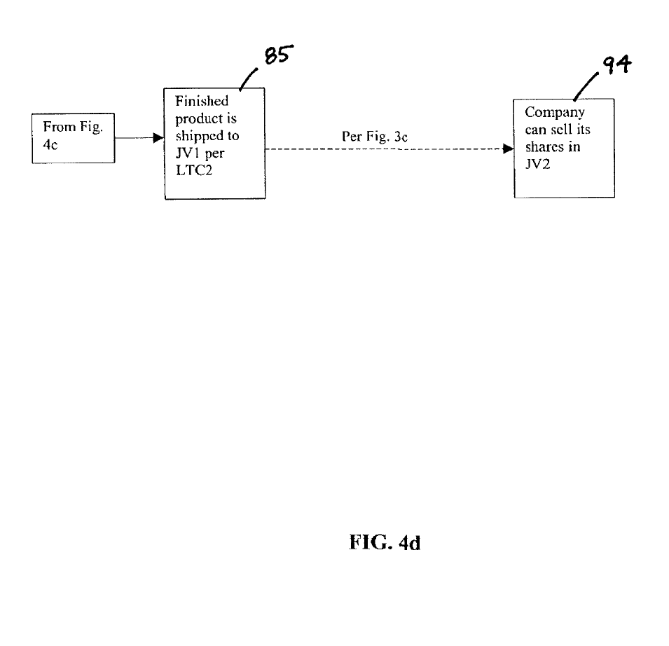

FIGS. 4a, 4b, 4c and 4d illustrate the sequence of operation in the case where new facilities are required, and capital is needed for construction of the new plant, operation and/or to buy materials. As shown, the third party (VM) identifies 95 a good business opportunity overseas to manufacture/assemble a product required in that area. The third party brings the preliminary information to the “COMPANY” 96. This information consists of, but is not limited to: prices for similar but imported products from other countries, average labor costs, quantities needed in that country, is energy prices, etc. If interested, the “COMPANY” shall issue a letter of interest 97 stating that it wants to manufacture that product in that country to sell it there and elsewhere, specific quantities, facilities specifications, people to be employed, etc. VM takes the letter of interest mentioned above and discusses it 98 with all interested parties in that country. If seriously interested in this business, these parties shall issue a letter of interest 99 to VM, stating clearly what they have to offer: how many products will be purchased locally, how many exported, qualification of the people involved, etc. VM shall bring 100 the letter to the “COMPANY” for evaluation plus a detail description of the entire “PROJECT.” VM shall discuss in detail 101 creation and the percentages in JV1 and JV2, LTC1, LTC2, and OP(s). If negotiations are successful, “COMPANY” shall sign a confidential agreement 27, write a business plan 62 for JV2 and a feasibility study showing all costs for construction, operation components etc with the assistance of all parties. “COMPANY” shall issue letter(s) of intent 63 spelling out clearly all conditions for creation of the JV1, JV2, OP's for transferring the goods between companies, LTC1, LTC2 and all other necessary data. Armed with 62 VM shall approach the F(s) 64. If F(s) evaluate data and agree 65 to provide financing, the F(s) shall issue letters of intent 66 spelling out clearly the amounts of money to be provided as equity, lease conditions and all other requirements. VM shall present the letters from F(s) to “COMPANY” 102 and all local interested parties. The “COMPANY” and the local interested parties shall agree 103 to enter a joint venture JV2 per LTC2. JV1 is formed 69 and “COMPANY” issues the LTC1 to JV1. C shall become JV2 after negotiations 70 between all parties: W, M, VM, “COMPANY,” F(s) and C owners, if they exist. JV1 shall issue 71 the LTC2.

Some of the F(s) providing the equity capital shall deposit the money 72 needed for the “PROJECT” in accordance with the feasibility study, to B. One or more F(s) shall issue the loan guarantees 73 to other F(s). One or more F(s) shall sign 74 the lease agreement with JV2. The F(s) who obtained the lease business shall pay 75 the finder's fee(s) to JV1 or VM. The F(s) providing the lease shall deposit money 76 in accordance with the feasibility study and their letter of intent to B. B pays 77 V1 per updated prices and V1 pays a finder's fee to VM. V1 shall ship the purchased materials/equipment to JV2 with the shipping documents 78 stating the OP(s) as decided by the buyers and/or sellers. B shall wire 79 money to BC. BC pays V2 and I per updated prices 80 and V2 and I pays a finder's fee to VM as agreed. The final payment to I shall be one year after JV2 modernization 81 is completed. V1 shall start shipping components and JV2 shall assemble/manufacture 83 per LTC2. B shall return D, which is the profit 82 from the project and/or project management fee to JV1 or VM. A shall be identified or formed 84. The finished products are shipped 85 to JV1 per LTC2 but at the location or warehouse decided by “COMPANY.” JV1 transfers the goods per LTC1 190. The equivalent for labor, other expenses and profits, in finished products per LTC2 who belongs to the local partners/employees are sold to A and/or others 86 or if A finds clients 87 for the finished products shall be paid a FF by JV2. A pays 88 JV2 for products before and/or after it sells them to others. JV2 pays 89 the profits to local partners and the F(s) who provided the equity capital.

“COMPANY” pays LP 90 to the F(s) who are the lessors. JV1 pays 91 US salary in US dollars to local manager/person responsible for JV2 operation. JV1 shall pay 92 the profits to the partners in the United States. VM can sell 93 some shares in JV1, JV2 and A to others. After the lease is paid, the “COMPANY” can sell its share in JV2 94 to local buyers.

To ensure the optimum operation of the JV and to avoid problems of any kind of the products manufactured and/or assembled overseas the, responsible, people employed by that overseas supplier shall receive a salary paid in US$ in the United States. If there are problems the salary shall not be paid and all or part the damages must be deducted from their pay.

Certain “Safety and Control Measures” are necessary to guarantee the complete success of the “PROJECT.” That means the following:

a) The buyers will receive the quantity and quality of goods as specified in contract(s) because the JV2 management will receive an extra salary in US dollars in the United States.

b) The sellers (V) and contractors (I) will be paid for the products and/or services provided, by reputable banks, and B shall pay V in the United States avoiding the cost of LC. BC, the B branch in that specific country, shall pay I, a contractor in that country leaving out any doubt that the client does not have enough money to pay for his services.

c) The profits will be distributed to everybody according to the number of shares owned in a specific operation including the third party at the desired location(s)

d) Once the project was identified and started the initiators, facilitators, promoters etc, will not abandon, or slow down the intensity of their work until the project is completed and operated successfully. The shares owned by the third party (VM) have no value unless the operation is profitable.

e) The lenders/leasers will be paid in time and without any problems by a “COMPANY” located in the United States.

f) Avoid currency fluctuations and, if possible, exchange fees. All transactions will be in US dollars.

g) Minimize the taxes paid by everyone anywhere to a wide range of interested parties.

h) Minimize/avoid where and if possible the number of LC(s) presently necessary in the international trade.

i) Optimize third party profits, and profits in general.

The “PROJECT” must meet the requirements imposed by all the financial institutions mentioned above, buyers, sellers, lessors, lessee and contractors. If the amount of capital required by the “PROJECT” exceeds the limits allowed by the respective(s) financial institutions, the “PROJECT” must be divided into “SUBPROJECTS” to accommodate their requirements and/or limitations. Each “SUBPROJECT” shall become a stand alone “PROJECT” and have its own Finder's Fee.

To meet all conditions and satisfy everyone, the sequence of operation, project architecture, safety and control measure(s) of the “PROJECT” need a special, custom made engineering. This type of work shall be called “Financial Engineering.”

F) After the lease has been paid, the “COMPANY” should divest, in time, all of the “COMPANY” holdings in the international, joint ventures, via IPO's through their stock markets, at a profit. The “COMPANY” should also transfer all resulting cash, to the United States, through the regular channels. The “COMPANY” shall continue to do business with its partners. The form of business should be a “License” and/or “Manufacturing Contract” which can be also a technology transfer.

G) With the cash realized from implementation of step “F” above, the “COMPANY” will purchase small technology companies, with products, that are complementary to “COMPANY” counterparts. In this way, the “COMPANY” can increase its product line and become more competitive.

Internationally, the “Office Equipment Maker” will have strong advantages and no real competition for the time being:

1) Good business relations with foreign phone, utilities or airline companies, to whom the “COMPANY” sold, through negotiations or bidding process the United States phone business or utility or aviation equipment/services. These companies can have a major roll in the “COMPANY” international expansion, under the “Office Equipment Maker” brand name. They are strong in their own countries and have purchase, or strategic investments in similar businesses in other parts of the world: South America, Eastern Europe, etc. They can introduce the “COMPANY” to their customers, for a finder's fee. To stimulate the “COMPANY” prospective customers the power, natural gas distribution, phone and airlines companies can provide incentives to their customers who bought “Business Solutions” services under the form of rebates or free tickets.

2) As an investor in media businesses mentioned above, the “COMPANY” can suggest investment in similar companies located overseas. This will help the “COMPANY” internationally with the advertising campaign(s). For products manufactured overseas, the “COMPANY” can obtain better rates and advice from the interested locals who know their market(s) and customers. Overseas media companies wholly owned subsidiary or joint ventures of the United States or US-based media enterprises should advertise American products. The US media-holding corporation shall recruit businesses interested in selling their products overseas. The US-based companies must receive the advertising fees in US dollars and in the United States. From this money, only the part to cover the expenses shall be sent overseas. The rest shall stay in the United States. This way, the bad habit of not reporting the right amount of profits is eliminated and also the exchange and repatriation fees. Also, the US media companies shall collect, overseas, the advertising fees for country products that are targeted for export in the US or elsewhere, and where the advertising will be done by US or US overseas subsidiaries.

Certain “Tax Optimization Packages” are available for multinational, private or government, international marketing, barters and import/export, organizations, mergers and acquisitions and/or other intermediary company interested in the above. They are as follows:

1. Method to Optimize and Increase the Revenue from Import Taxes Imposed by Government(s), Revenue from Barters, Import/Export Operations.

The international shipping documents can show a different amount of dollars than the actual amount paid for the exported products. If the amount is lower, it will be lower import taxes that improve the bottom line of the importing company. If the amount of dollars is higher, the profits will be lower for the importing company affecting their bottom line.

This will work best if companies, the importing and the exporting ones, are part of the same enterprise as joint ventures or wholly own subsidiaries. In the case of the joint venture, the partners in the exporting country may be interested in keeping some of the profits in other countries with a lower tax bracket. The decision shall be made taking into consideration all taxes in the countries involved. The OP(s) must be decided by common agreement between buyer(s) and seller(s).

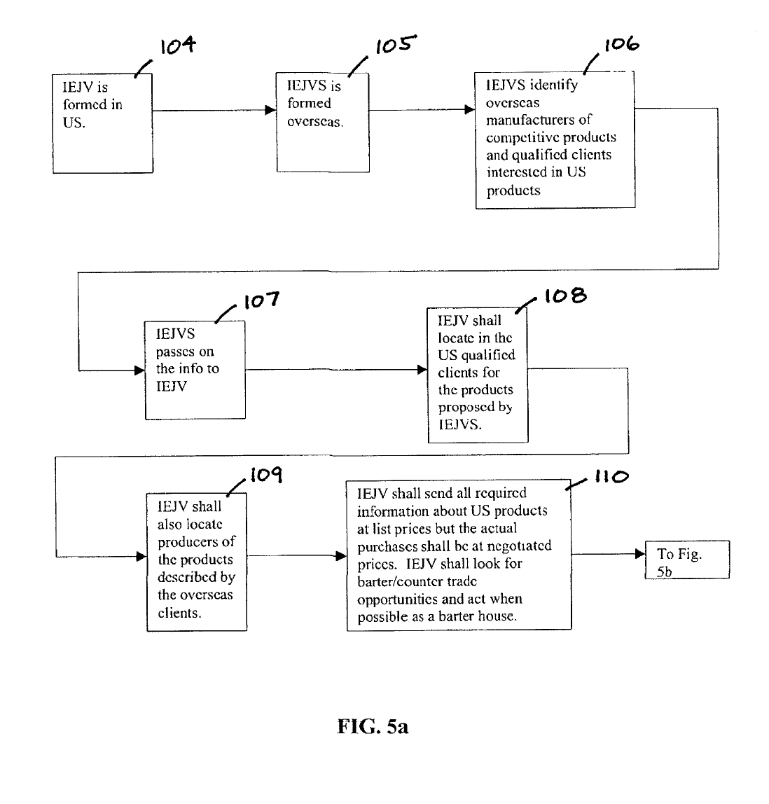

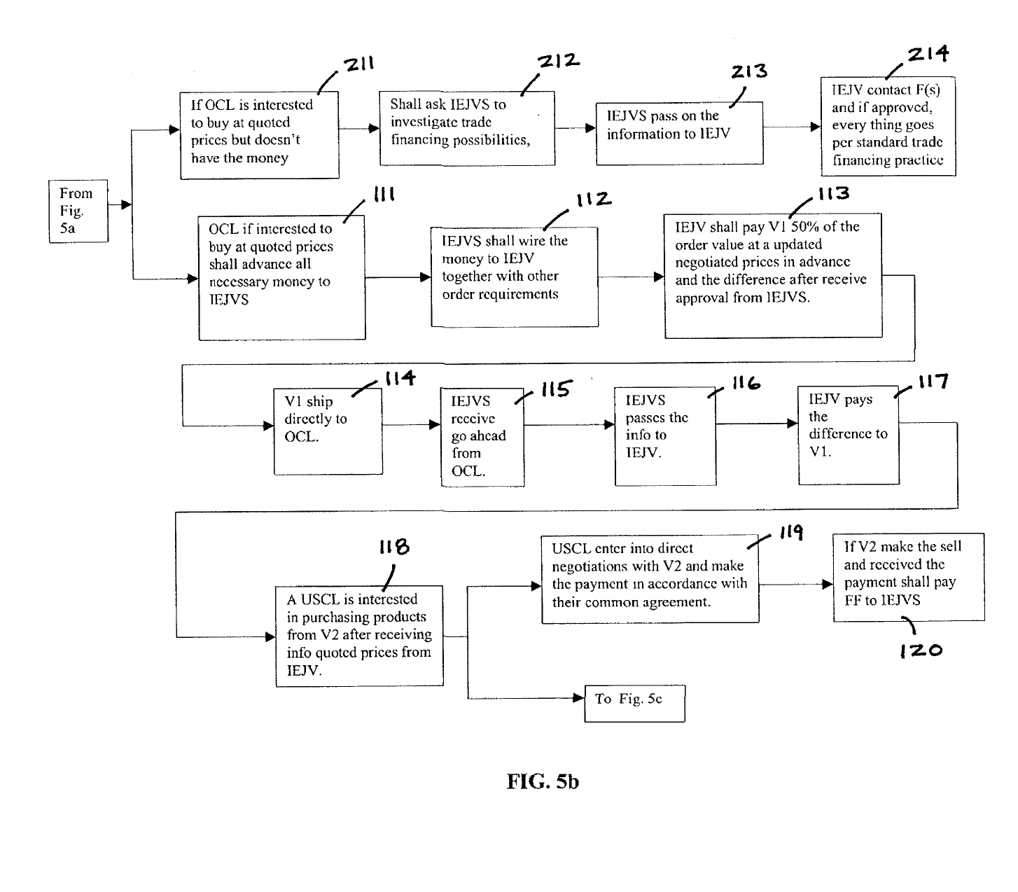

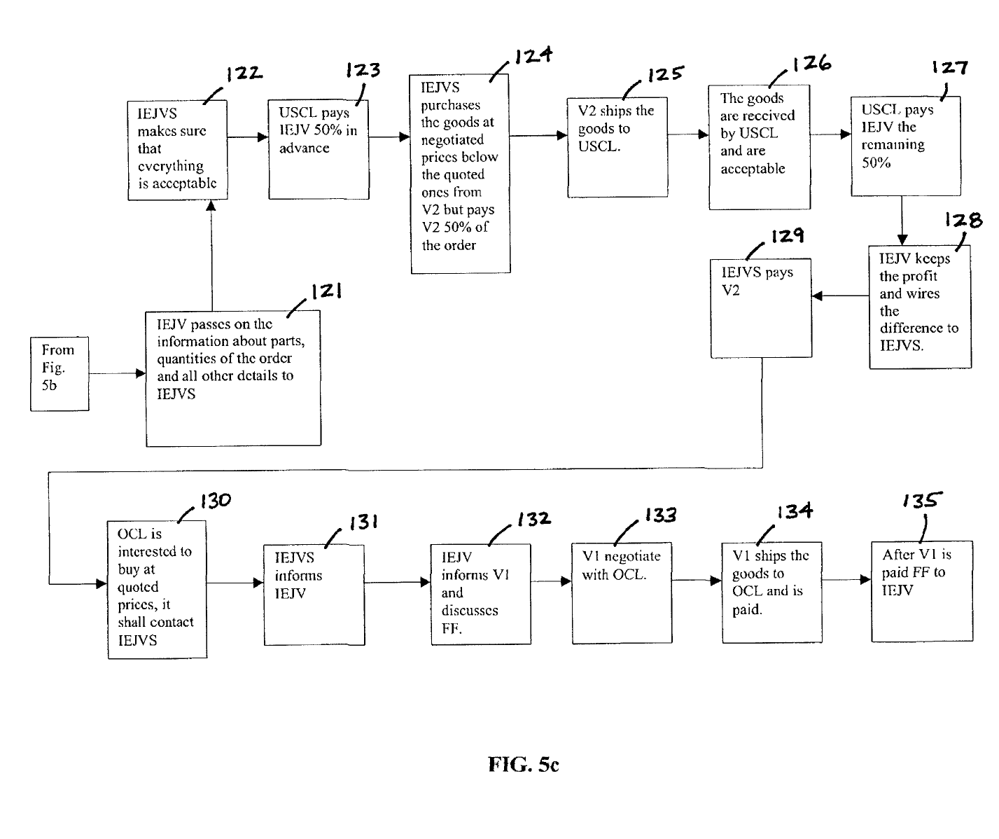

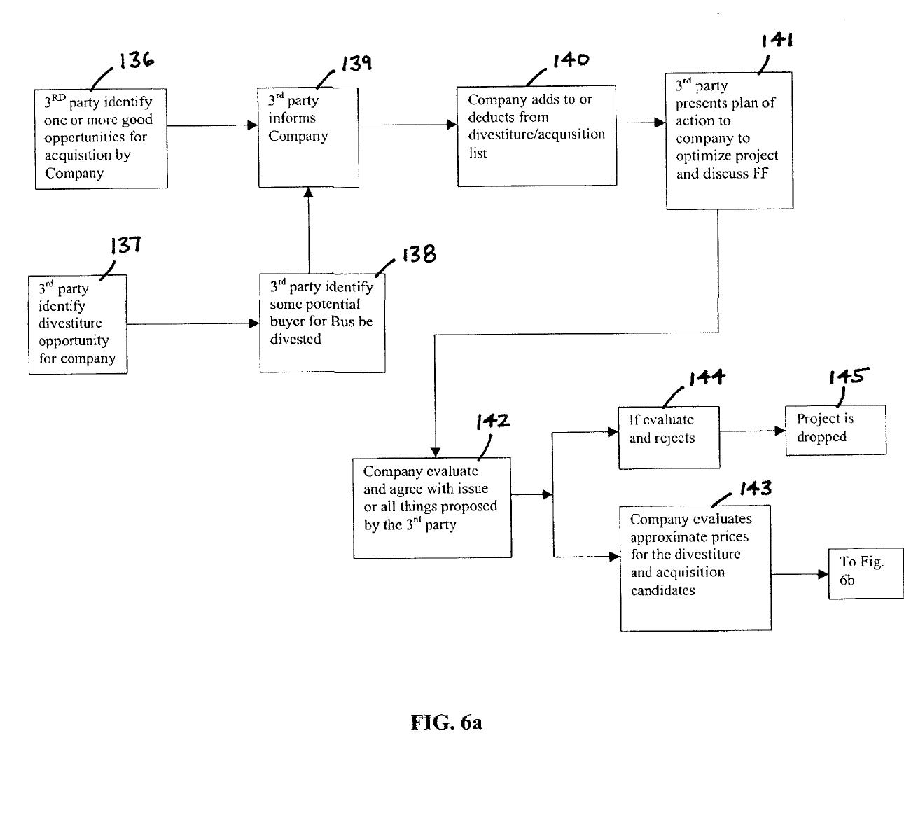

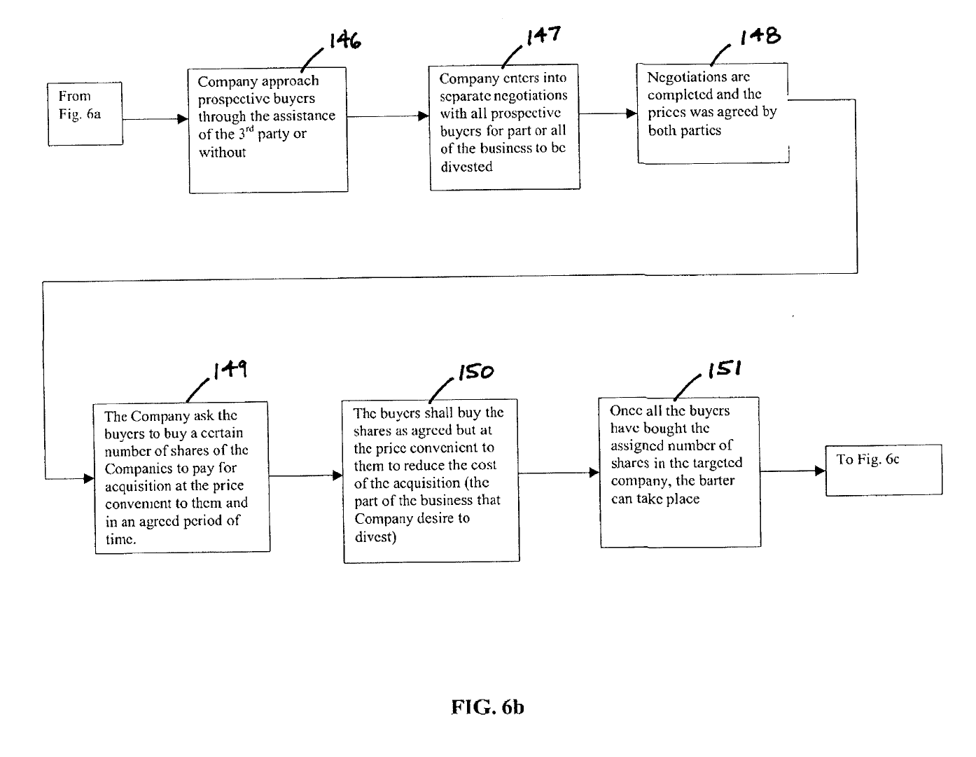

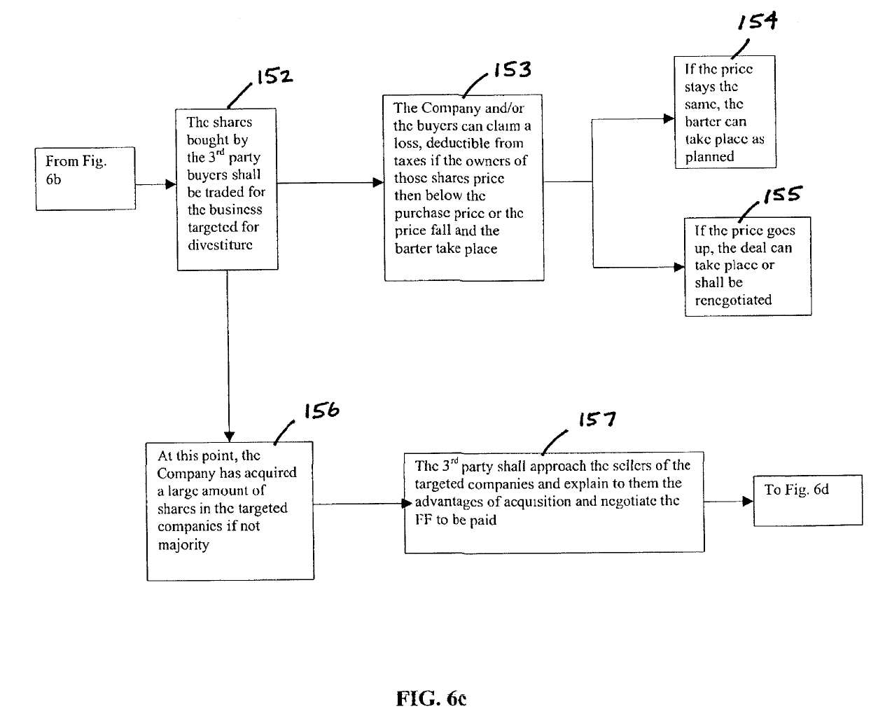

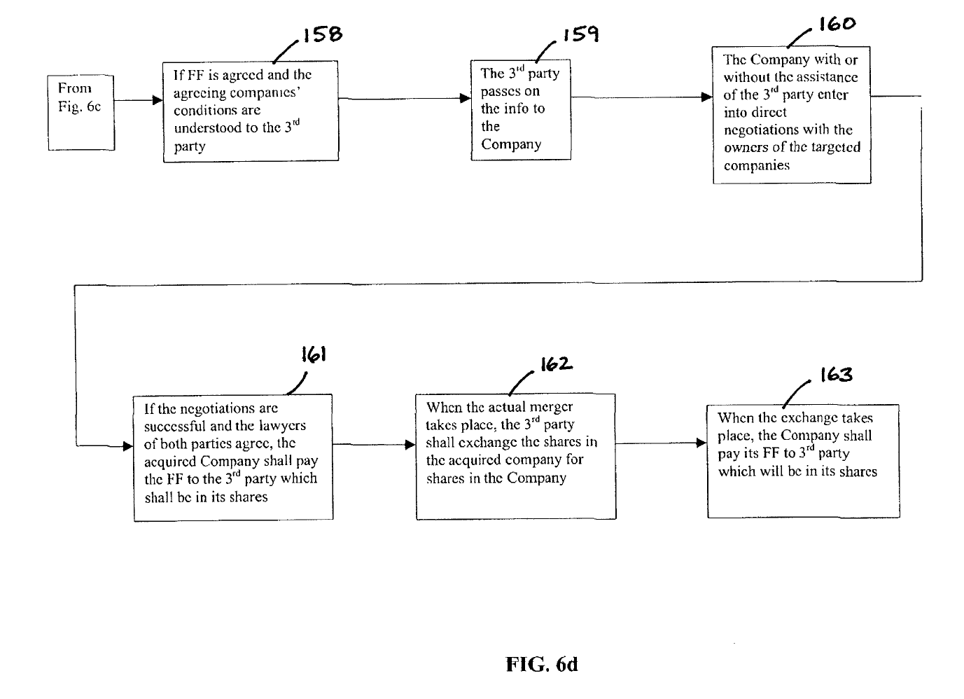

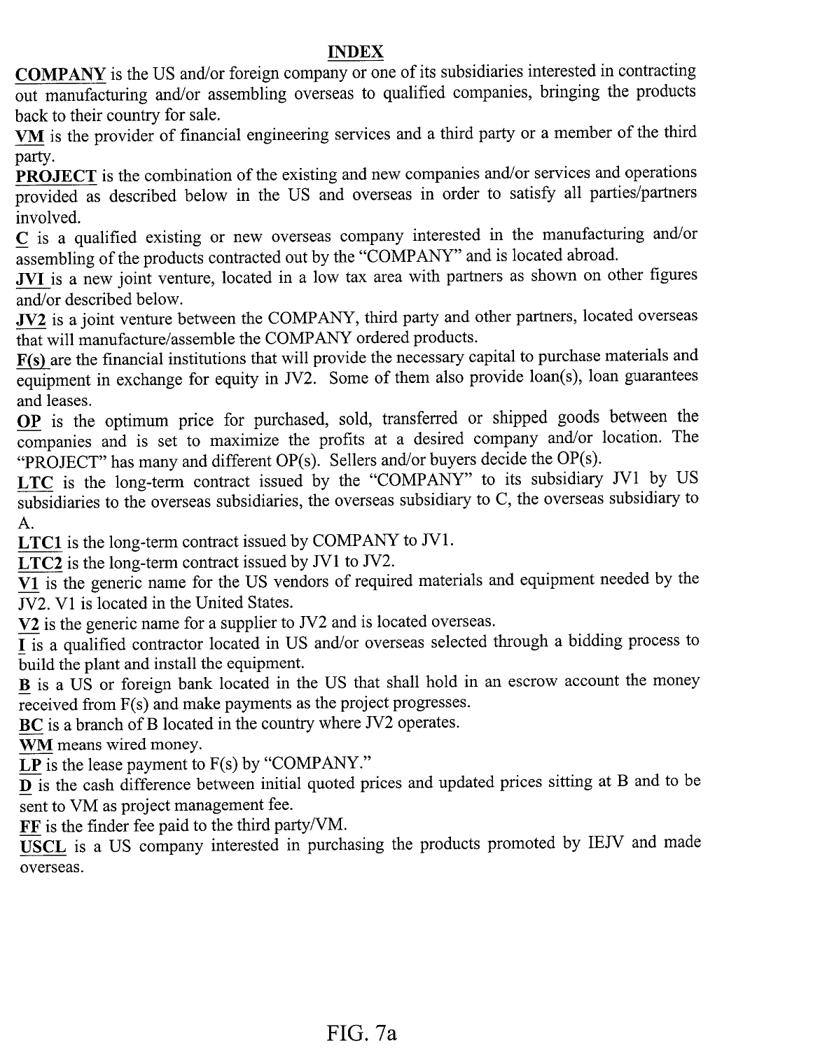

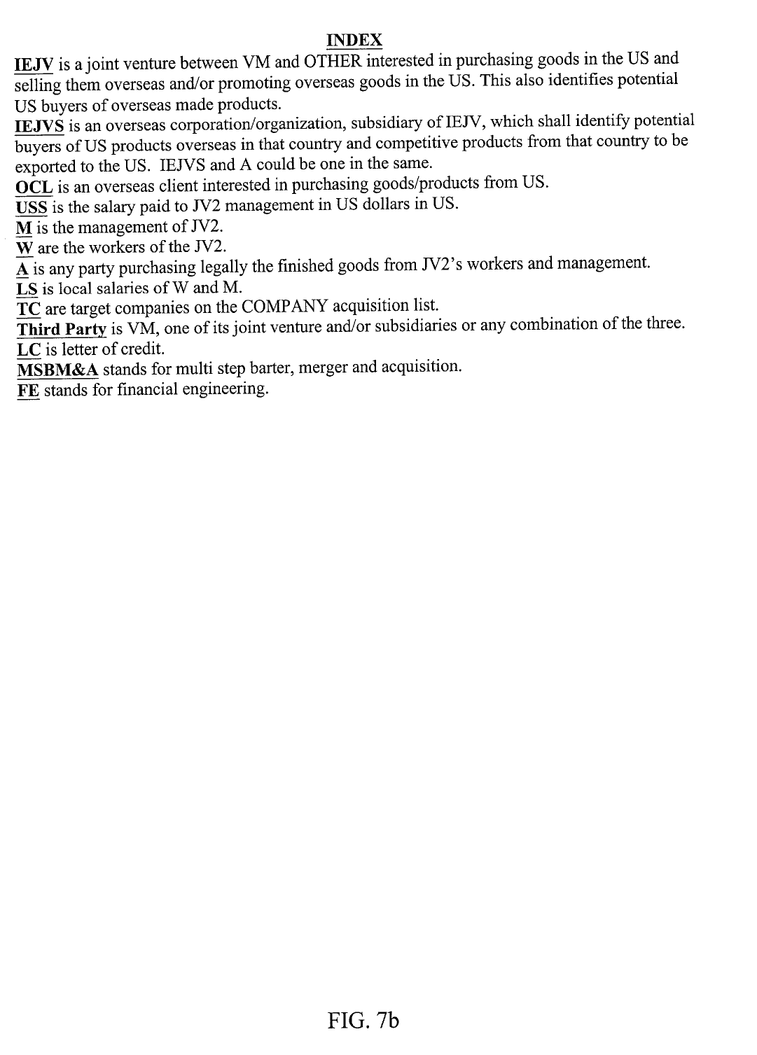

Regarding the sequence of operation as shown in FIG. 5, IEJV shall be formed 104 in the United States. IEJVS, its subsidiary, shall be formed 105 overseas. IEJVS shall start by identifying 106 overseas manufacturers of competitive products and overseas qualified clients interested in purchasing, competitive US products and pass the information 107 to IEJV. IEJV shall locate 108, in the United States, qualified clients for the overseas made products proposed by IEJVS. It shall also locate 109 producers of the products desired by the overseas clients. IEJV shall send all required information 110 about US products at list or quoted prices, but all purchases shall be at negotiated prices. The difference is the IEJV profit. The overseas client (OCL), if interested to buy at quoted prices, shall advance all necessary money 111 to IEJVS. IEJVS shall wire 112 the money to IEJV. IEJV shall pay to V1, 50% of the product cost at negotiated prices in advance 113 and the difference after receive approval from IEJVS. V1 shall ship 114 the goods directly to OCL. IEJVS shall receive 115 the go ahead from OCL. IEJVS will pass this on to IEJV 116. IEJV pays 117 the difference to Vi. If the OCL is interested in buying at quoted prices, but does not have the money 211, it shall ask IEJVS to investigate trade financing possibilities 212. IEJVS passes this on to EJV 213 and IEJV contracts F(s) and, if approved, everything goes forward per standard trade financing practices 214. If a USCL is interested 118 in purchasing products from V2 after receiving information at quoted prices from IEJV a few things can happen:

1. USCL shall enter in direct negotiations 119 with V2 and make payment in accordance with their common agreement. If V2 made the sales and received the payment 120, it shall pay a finder's fee to IEJVS.

2. IEJV shall pass the information about the order 121 including prices to IEJVS. IEJVS makes sure 122 that everything is acceptable to V2. If it is, the USCL shall pay 50% of the value of the order 123 in advance to IEJV. IEJVS shall purchase 124 the goods wanted by USCL at negotiated prices, below the quoted ones from V2 with the first payment at 50% of the order value. V2 shall ship the goods 125 directly to USCL. The goods are received 126 by the USCL. The USCL pays to IEJV the remaining 50% 127. IEJV keeps the profit and wires to IEJVS the amount needed 128 to be paid to V2. IEJVS pays V2 129.

There is an alternative that could happen in the United States with V1. If the OCL is interested in buying US products at quoted prices 130, it shall contact IEJVS. IEJVS shall inform 131 IEJV. IEJV shall inform V1 and discuss 132 the finder's fee. V1 shall negotiate 133 with OCL for everything, including the payment method. V1 ships the goods 134 and receives payment. V1 pays the finder's fee to IEJV 135. The products shall be shipped directly from V1 and V2 facilities to USCL and OCL saving money for the export companies (IEJV and IEJVS).

2. The M & A Optimization—Multi Step Barter Method.

The third party identifies one or more good acquisition opportunities 136 for the “COMPANY.” It can also identify candidates 137 to be divested by the “COMPANY.” The third party identifies some potential buyers 138 for the divestiture candidates. The third party shall inform the “COMPANY” 139 and the “COMPANY” may add to the divestiture and acquisition 140 list or deduct. The third party presents to the “COMPANY” a plan of action 141 to optimize the “PROJECT” and discuss the Finder's Fee.

The “COMPANY” makes its own evaluation 142 and agrees with some or all of the things proposed by the third party. “COMPANY” decides the approximate prices for the divestiture and acquisition candidates 143 with or without the assistance of the third party. If the “COMPANY” evaluates 144 and rejects, then the PROJECT is dropped 145. The “COMPANY” shall approach the prospective buyers 146 with or without the assistance of the third party. “COMPANY” enters 147 into separate negotiations with all prospective buyers for part or all of the businesses to be divested. After the negotiations are completed and the purchasing price was agreed 148 upon by both parties, the “COMPANY” shall ask each buyer to purchase a certain number of shares, in some or all of the acquisition targets, equal in value with the purchasing price of the business, or a share of it, to be divested by the “COMPANY” in an agreed period of time 149. This way the buyers can negotiate 150 with the owners of companies in the “COMPANY” acquisition list to purchase some or all of their shares at a price convenient to them reducing the cost of their acquisition. Once all the buyers have purchased all the assigned shares in the targeted companies 151 (the “TC(s)”), the barter can take place. The shares bought by the third party buyers shall be traded 152 for the “COMPANY” businesses in the divestiture list and as agreed. The shares in the TC(s) at the time of the barter(s) can have different values than the purchase price due to many factors. If the owners of those shares (TC) price them below the purchased price and/or the price falls and the barter takes place as agreed all parties will have a loss 153. If the prices stay the same, the barter shall take place as planned 154. If the prices go up, the deal can take place or be renegotiated 155.

At this point, and after the barter takes place, “COMPANY” has acquired a substantial amount of shares in TC(s), if not the majority 156. The third party shall approach the owners and/or managers of the TC(s) and explain to them the advantages for them and their company if acquired through a friendly merger by the “COMPANY” and not by others, convince them to enter into negotiations with “COMPANY” and negotiate the Finder's Fee to be paid by the TC to third party if the merger will take place 157. If the Finder's Fee is agreed, and the TC conditions are clearly understood by the third party 158, the third party shall pass on all the information to “COMPANY” 159. “COMPANY” with/without the assistance of the third party shall enter in negotiations with the owners/managers of the TC 160. If the negotiations are successful and all managers, owners and lawyers involved are in agreement the TC shall pay the Finder's Fee to the third party 161. When the actual merger takes place, the third party shall exchange its share in the acquired company for shares in the “COMPANY” 162. During the exchange or short time after, and as agreed, the “COMPANY” shall pay its Finder's Fee to the third party in “COMPANY” shares 163.

It is to be understood that, although references in this detailed description are made to the methods of the present being implemented by a United States company, the methods of the present invention could be implemented by companies located in other countries and other countries as well in the same fashion and manner as disclosed herein.

Based upon the foregoing, it will be apparent that there has been provided a method for business solutions which, if implemented correctly, can increase the productivity of a business and also lower the cost of products and services provided by that business or by its related companies.

The principles of this invention having been fully explained in connection with the foregoing, I hereby claim as my invention:

1. A business solution method for use where existing manufacturing facilities are adequate and there is no need for expansion and/or modernization which comprises the steps of
identifying a U.S. business interested in outsourcing a product overseas,
identifying a contractor to provide quality products,
forming one or more joint ventures to provide equity for manufacturing operations,
wherein none of the main parties involved, the company interested in outsourcing and the contracting company, will use their capital to buy materials and/or components necessary to manufacture or assemble the finished product.

2. A business solution method for use where existing manufacturing facilities are adequate or are in need of modernization or where new facilities are needed which comprises the steps of
identifying a U.S. business interested in outsourcing a product overseas,
identifying a contractor to provide quality products,
forming one or more joint ventures to provide equity for the manufacture of the products,
wherein all operations are or could become a license and the revenues belonging to all parties including a third party are easier to account because the number of total finished products can and shall be determined with accuracy and in advance, all transactions between U.S. companies and their overseas manufacturing subsidiaries or contracting companies being in kind, and
wherein, if the contracting company needs more finished product to sell on its own, the components purchased for that purpose will be part of the same order given by the outsourcing company to a vendor so as to take advantage of lower prices offered by a larger order, thereby making the sale more profitable.

3. The method of claim 2 including the step of creating and/or raising capital, which capital is necessary to acquire new businesses, through divestiture of shares in overseas business wherein the business utilizing the method will continue to is do business through a licensing agreement or manufacturing contract based upon the long-term contract issued by and/or between the parties to the one or more joint ventures.

4. The method of claim 2 including the steps of paying workers and management compensation in kind, paying profits for local owners in kind and selling the finished product belonging to them in local and/or international markets through designated agents wherein product quality is improved.

5. The method of claim 2 including the step of making a private company to pay dual salaries, one salary in the foreign country paid with finished products and a second in U.S. dollars paid in the United States.

6. The method of claim 2 including the step of paying some of the expenses of one or more of the joint ventures from a location with high taxes so as to be able to deduct from the profit at that location to save on taxes.

7. A method for providing an organization which comprises the steps of
providing one or more third party multinational and/or international organizations that has as its main business marketing, patents, manufacturing contracts, technology transfers, licenses, imports, exports, barters, counter trade, buying and/or purchasing in more than one country,
requiring that such organization identifies, promotes, develops and provides financing, financing arrangements and investment banking services on an ongoing basis for a wide range of serious competing business opportunities, investments, products or services provided by competing suppliers and sold to any and all interested parties regardless of location, and
requiring that such organization also provides management consulting and business solutions through joint ventures or not, domestic or international, regardless of location of the parties or business opportunity.

8. A method for compensating an organization which comprises the steps of
providing a third party organization for marketing successful patents, imports, exports, barters, counter trade, manufacturing contracts, technology transfers, licenses, and investments, and providing investment banking services, and
being paid a finders fee for promoting competing products and services, both domestic and/or international, regardless of the location of the third party organization, the buyers or the sellers, such fee being paid only if the supplier of the product or services has received payment from the buyers found by the third party and if the third party has no prior agreements to represent the sellers or the buyers, such fee being paid in shares of the business and/or in cash in a percentage of the value of the order and such fee being paid by investors, owners, buyers, sellers or any other beneficiaries if such sales, business opportunities and/or investments become reality and/or become more profitable due to modernization, increase in business volume and/or quality.

9. The method of claim 8 including the step of providing export shipping documents to show the value of the exported goods as decided by the buyer or seller if trading is done between a parent company and an overseas subsidiary or if the goods are sold by a third party vendor or purchased by a third party buyer.

10. The method of claim 8 wherein said method is to be used by a marketing, import/export, barter, counter trade and trade financing organization that is privately or government owned, includes in its operation and has as revenue a finder's fee, mark-ups and barter profits, eliminates product storage by the importers/exporters, eliminates export licenses and requires that the manufacturers export the product under their name at a higher profit, and eliminates, where possible, the letter of credit and all banking fees associated with the import/export operations.

11. The method of claim 8 including the step of providing a company subsidiary located overseas that will cover all of its expenses by revenues generated in that country, thereby reducing the risks associated with currency exchanges and poor management of monies received from the U.S. parent company.

12. A method of financing a major investment, lease and/or equity, comprising the steps of
utilizing one or more financial institutions in a venture or a series of ventures to provide all capital required for financing new construction, modernization and/or operation and
making the financing risk-free for certain partners in that venture or ventures and for other parties benefiting from the investment or business opportunity.

13. A method of business which comprises providing a U.S. based media/advertising company that receives advertising fees in U.S. dollars in the U.S., from U.S. companies, for advertising products overseas through the media/advertising companies' overseas subsidiaries to receive advertising fees for products manufactured locally and to be exported in the United States, the advertising being done in the United States by the U.S. media company's local subsidiaries.

14. A method of business which comprises protecting against currency exchange risk by making all payments between a U.S. company doing business with other U.S. companies overseas in the United States and in U.S. dollars.

15. A financial method of engineering which comprises providing financial engineering wherein proper design and implementation of a project is accomplished according to prescribed investment guidelines to the satisfaction and requirements of all parties.

16. A method for improving the performance and profitability of a company which comprises the steps of
increasing the company's business—services operation, and
acquiring other companies that are specialists in their respective areas of products or services.

17. The method of claim 16 wherein said business-services operations increasing step includes the step of retaining specialists that shall recommend methods and ways to improve and reduce costs associated with purchasing raw materials, components, energy, production equipment and services, employee hiring and/or benefits, labor, marketing, engineering, taxes, finances, accounting, communications, travel, transportation, shipping, legal services, insurance, management, compensation levels, paperwork and union relations, domestic and international.

18. The method of claim 16 wherein said business-services operations increasing step further includes the step of quantifying all savings through means of a feasibility study.

19. The method of claim 16 wherein said business-services operations increasing step further includes the step of hiring and/or contracting experts to form a management advisory team to identify and implement the business saving measures recommended to clients.

20. The method claim 16 wherein the management advisory team formation step includes the step of compensating members of the management advisory team such that company employees shall receive, in addition to base salary and benefits, a one-time bonus proportional with revenues generated by them for the company from each customer that implements the business solution measures, consultants shall receive a monthly retainer, no benefits and fifty percent of each payment received by the company for each successfully implemented business solution method.

21. The method claim 16 wherein acquisition step includes one or more of the following steps
acquiring an assembler/manufacture/trader/up-grader of desk tops, portable and other computers and services,
acquiring a manufacturer of office equipment,
acquiring a provider of software and services designed to increase the productivity, reliability and recoverability of its client's core informational technology operation,
acquiring a supplier of application server software and services that enable the effective and efficient enterprise-wide deployment and management of applications,
acquiring a designer, developer, manufacturer, and marketer of digital imaging products,
acquiring a developer, marketer and supporter of system software products that are designed to improve productivity and application development, implementation and maintenance and also offer system analysis, design, program, system planning and/or consulting,
acquiring a designer, manufacturer and marketer of computer-based information systems and related products and services,
acquiring a provider of information technology services through outsourcing, system integration, information technology and management consulting services,
acquiring a telecom manufacturer involved in networking, enterprise/consumer and telecom components, such manufacturer also being capable of designing, developing, manufacturing and/or servicing systems and software which network operators and other service providers to provide wire line/wireless access,
acquiring a machine tool and factory automation company that is engaged in research, development, manufacturer and service of machine tools, electronic controls and communication products including control logic, sensors, human-machine interface devices and software products,
acquiring an energy savings (ESCO) for advising customers how to save energy, reduce purchasing costs and identify low cost suppliers in an area, and
acquiring a software company whose main products are helping clients with their income taxes and project/investment financial analysis/or decisions.

22. The method of claim 16 including the additional step of having the company continue to do business with existing partners in the form of a license and/or manufacturing contract wherein a finders fee is paid to a contractor responsible for such a relationship from the licensor and licensee.

23. The method of claim 16 wherein said business-services operations increasing step includes the step of manufacturing and/or assembling products overseas and paying the responsible people employed by that overseas manufacturer/supplier with a salary paid in U.S. dollars and providing for nonpayment of such salary in the event that products are not properly manufactured and/or assembled.

24. The method of claim 21 including the step of providing a multiple is step in barter mergers and acquisitions method that requires each party to advise the other and mutuality of working toward the interest of both parties thereby substantially reducing the costs associated with multiple acquisitions including taxes associated with acquisitions.

25. The method of claim 21 wherein the compensation fee for a third party identifying an organization is in shares of both companies and a third party providing services being paid only if the merger takes place.

26. The method of claim 21 including the step of providing a retirement pension/benefit for employees and the third party companies purchasing the shares in the transferred companies resulting in the transfer of such retirement pension/benefit package.

27. The method of claim 16 including the step of providing a customer that shall compensate the company for its work with a substantial and negotiated percentage of the savings for a period of several years, starting from the day that implementation is complete.

28. The method of claim 27 wherein the percentage of compensation is 60 to 90% of the savings and the period is at least 3 years.
